(19) United States
(12) Patent Application Publication
(10) Pub. No.: US 2008/0288984 A1
(43) Pub. Date: Nov. 20, 2008

(54) MINOR CHANNEL SELECTION METHOD FOR DIGITAL TELEVISION

(75) Inventor: Jae Young Lee, Guri-si (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 11/842,417

(22) Filed: Aug. 21, 2007

(30) Foreign Application Priority Data
May 15, 2007 (KR) 10-2007-0047044

(51) Int. Cl. G06F 3/00

(52) U.S. Cl. 725/56

(57) ABSTRACT

Disclosed herein is a minor channel selection method for digital televisions. The method comprises storing a major channel number in response to an input of the major channel number, followed by determining whether or not the major channel number is consistently input for a first preset time; determining whether or not a minor channel number is input before an elapse of a second preset time after a complete input of the major channel number, if the major channel number is consistently input for the first preset time; and selecting a minor channel corresponding to the minor channel number, if the minor channel number is input before the elapse of the second preset time. With this method, it is possible to conveniently select a minor channel since no delimiter is needed to be inputted between major and minor channel numbers to divide them from each other.

### BACKGROUND OF THE INVENTION

1. Field of the Invention

The present invention relates to digital televisions, and more particularly to a minor channel selection method for digital televisions.

2. Description of the Related Art

In general, program and system information protocol (PSIP) data is a set of tables including system information (SI) required for digital broadcasting and digital broadcasting stream processing, and is transmitted in a state of being contained in every digital broadcasting stream having a base packet identifier (PID).

The PSIP data includes a system time table (STT) for providing system time information, a rating region table (RRT) for providing rating information for each geographic region, a master guide table (MGT) for providing packet identifier (PID) information of an event information table (EIT) that constitutes detailed information of each program, and a virtual channel table (VCT) for providing information about actual digital channels within high-frequency channels, such as the number of channels, video/audio/PCR PIDs, etc. Accordingly, channel information included in the digital broadcasting stream can be obtained from such various kinds of system information.

The channel information includes logical and physical channel numbers, video/audio/PCR PIDs, broadcasting stations to which channels are allocated, and detailed information on programs offered through the channels. Here, the detailed information on the programs includes information on titles, genres, schedules, etc.

The logical channel number is not a channel number based on a high-frequency band. Thus, in order to select a channel corresponding to a logical channel number selected by a user on a digital television, a physical channel number corresponding to the logical channel number must be determined, followed by selecting the channel according to a high-frequency channel number.

In order to extract a program corresponding to a selected minor channel from a digital broadcasting stream received through the selected channel, a channel map is provided to output the program relating to the selected channel by setting PIDs, i.e., video/audio/PCR PIDs, to selectively decode video and audio data corresponding to PIDs.

The channel map contains information about channels that can be selected by a digital television, and provides broadcasting information and a logical channel number corresponding to a physical channel number. Accordingly, for the digital television, the user requests channel switching to the digital television in such a manner of directly pushing or inputting channel switching (up or down) keys or numeral keys (channel numbers) on a remote controller or a front panel, and then, the digital television actually performs the channel switching by determining a corresponding physical channel number and selecting a high-frequency band with the channel map.

Accordingly, the user can select major and minor channels by using the channel switching keys or the numeral keys on the remote control.

However, with such a configuration as described above, it is difficult for the user to recognize the channel number since the major and minor channels are displayed only with figures.

To facilitate recognition of the major and minor channels, a special symbol, such as a delimiter ‘-’, is provided to the minor channel in the prior art.

Hence, in the case of selecting a minor channel, 9-2, a numeral key ‘9’ is inputted, followed by inputting ‘-’ and ‘2’ in this order.

As such, the conventional technique has a problem in that, since it is necessary to input an additional delimiter, such as a special symbol, between the numeral keys, switching of the minor channel using the numeral keys is more complex than that of the major channel.

### SUMMARY OF THE INVENTION

The present invention is conceived to solve the problem of the conventional technique as described above, and an object of the present invention is to provide a minor channel selection method for a digital television that is performed in such a manner of consistently inputting a major channel number, followed by inputting a minor channel number.

It is another object of the present invention to provide the minor channel selection method for the digital television that enables the minor channel to be selected only with numeral keys without inputting a delimiter, ensuring convenience in selection of the minor channel.

According to one aspect of the present invention, there is provided a minor channel selection method for a digital television, comprising: storing a major channel number in response to an input of the major channel number, followed by determining whether or not the major channel number is consistently input for a first preset time; determining whether or not a minor channel number is input before an elapse of a second preset time after a complete input of the major channel number, if the major channel number is consistently input for the first preset time; and selecting a minor channel corresponding to the minor channel number, if the minor channel number is input before the elapse of the second preset time.

If the minor channel number is not input before the elapse of the second preset time, a major channel corresponding to the stored major channel number may be selected.

The method may further comprise displaying a delimiter to divide the major channel number from the minor channel number, and the major channel number, if the major channel number is consistently input for the first preset time.

According to another aspect of the present invention, there is provided a minor channel selection method for a digital television, comprising: storing major channel numbers in response to each input of the major channel numbers, followed by determining whether or not a last major channel number of the major channel numbers is consistently input for a first preset time; determining whether or not a minor channel number is input before an elapse of a second preset time after a complete input of the last major channel number, if the last major channel number is consistently input for the first preset time; and selecting a minor channel corresponding to the minor channel number, if the minor channel number is input before the elapse of the second preset time.

If the minor channel number is not input before the elapse of the second preset time, a major channel corresponding to the stored major channel numbers may be selected.

The method may further comprise displaying a delimiter to divide the major channel number from the minor channel number, and the major channel numbers, if the last major channel number is consistently input for the first preset time.

### BRIEF DESCRIPTION OF THE DRAWINGS

The above and other objects, features and advantages of the present invention will become apparent from the following description of exemplary embodiments given in conjunction with the accompanying drawings, in which:

FIG. 1 is a block diagram of a digital television according to an exemplary embodiment of the present invention;

FIG. 2 is a flow chart of a minor channel selection method for a digital television according to an exemplary embodiment of the present invention;

FIG. 3 shows an example of displaying major and minor channels of the digital television according to the exemplary embodiment; and

FIG. 4 is a flow chart of a process of inputting a channel number and selecting a channel by using a minor channel selection method for a digital television according to another exemplary embodiment of the present invention.

### DETAILED DESCRIPTION OF THE INVENTION

Exemplary embodiments of the present invention will be described in detail with reference to the accompanying drawings hereinafter.

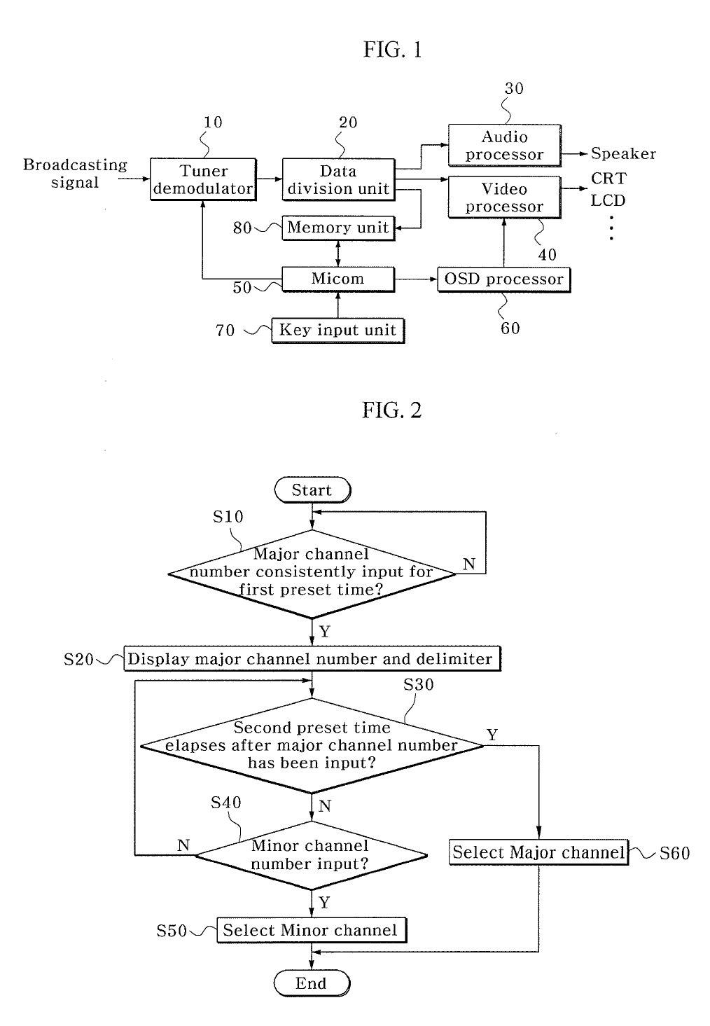

FIG. 1 is a block diagram of a digital television according to an exemplary embodiment of the present invention.

The digital television includes a tuner demodulator 10 to select only a desired channel frequency in response to a broadcasting signal and demodulate the selected channel frequency, a data division unit 20 to de-multiplex signals from the tuner demodulator 10 into a video signal, an audio signal and various kinds of supplemental information including program guide information, channel information, etc., a memory unit 80 to store the supplemental information divided by the data division unit 20, an audio processor 30 to decode the audio signal from the data division unit 20 and output the decoded signal through a speaker, a video processor 40 to decode the video signal from the data division unit 20 and display the decoded video signal on a display, such as cathode ray tube (CRT) or liquid crystal display (LCD), an on-screen display (OSD) processor 60 to perform OSD treatment on the supplemental information and channel information stored in the memory unit 80 to output the supplemental information and channel information on the display, a key input unit 70 to output key signals inputted by a user to a Micom 50, and the Micom 50 to control the overall operation of the digital television.

The key input unit 70 includes menu keys (not shown) to select menus, channel up/down keys (not shown) to sequentially switch the channels up and down, volume up/down keys to turn the volume up and down, and a plurality of numeral keys (not shown). Particularly, numerals from 0 to 9 are allocated to the numeral keys through which major and minor channels can be directly changed. In this embodiment, only the numeral keys are used to select the minor channels.

A minor channel selection method for a digital television controlled by the Micom 50 will be described in detail.

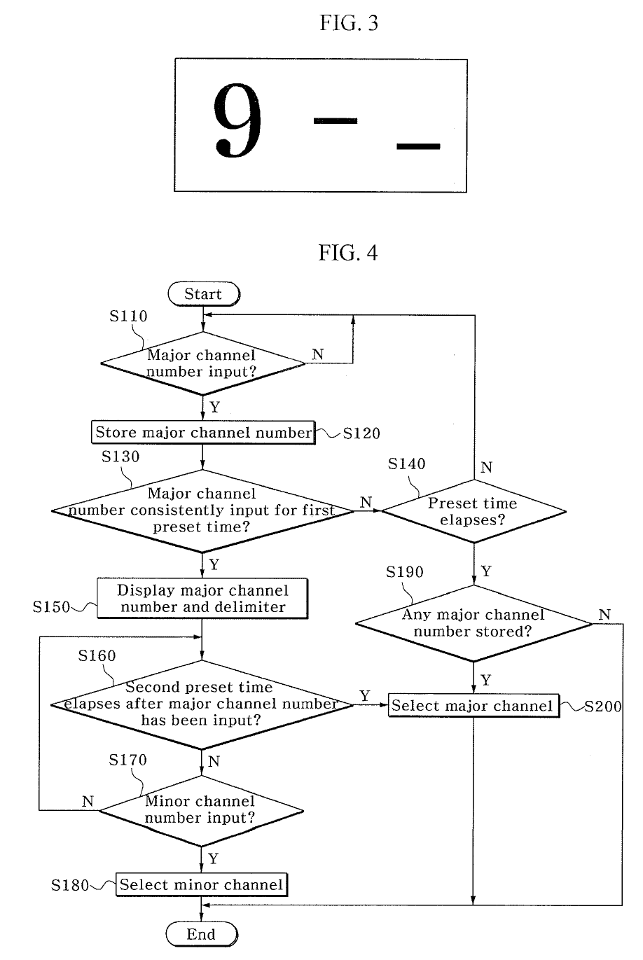

FIG. 2 is a flow chart of the minor channel selection method for the digital television according to an exemplary embodiment of the present invention. FIG. 3 shows an example of displaying major and minor channels of the digital television according to an exemplary embodiment of the present invention.

Referring to FIG. 2, in the minor channel selection method for the digital television according to this embodiment, first, it is determined whether or not a major channel number is input when a user pushes numeral keys from ‘0’ to ‘9’ on the key input unit 70 to select a minor channel number. When the major channel number is input, the inputted major channel number is stored, and, it is determined whether or not the major channel number is consistently input for a first preset time (S10).

If the major channel number is consistently input for the first preset time, the Micom 50 controls the OSD processor 60 to display the inputted major channel number (S20) such that the user can confirm the current major channel number.

That is, when the major channel number is completely input, the OSD processor 60 is controlled to display on a screen of a display the major channel number, a delimiter such as ‘-’, to divide the major channel number from the minor channel number, and a cursor such as ‘_’ at a point where the minor channel number will be input.

In FIG. 3, the major channel number, delimiter, and cursor are shown in this order as one example.

In the example shown in FIG. 3, the numeral key ‘9’ corresponding to the major channel number is displayed along with the delimiter and cursor by consistently pushing the numeral key ‘9’ for the first preset time.

On the other hand, if the major channel number is consistently input for the first preset time, it is determined whether or not a minor channel number is input before a second preset time elapses (S30 and S40).

In this case, if the minor channel number is not input until the second preset time elapses, the tuner demodulator 10 is controlled to select a major channel corresponding to the current major channel number (S60).

On the other hand, if the major channel number is consistently input for the first preset time and the minor channel number is then input before the elapse of the second preset time, the inputted minor channel number is displayed next the delimiter, and, the tuner demodulator 10 is controlled to select a minor channel corresponding to the minor channel number (S50).

Next, a process of inputting two digits or more of major and minor channel numbers and selecting major and minor channels corresponding thereto will be described in detail.

FIG. 4 is a flow chart of the process of inputting a channel number and selecting a channel by using a minor channel selection method for a digital television according to another exemplary embodiment of the invention.

Referring to FIG. 4, in the method of this embodiment, first, the Micom 50 determines whether or not major channel numbers are input through the numeral keys on the key input unit 70 (S110).

When the major channel numbers are input by the numeral keys on the key input unit 70, the Micom 50 stores the inputted major channel numbers (S120), and determines whether or not any of the stored major channel numbers are consistently input for a first preset time (S130).

If any of the major channel numbers are not consistently input for the first preset time, it is determined whether or not a preset time elapses after the major channel numbers have been completely input (S140). If the preset time has not elapsed, it is determined whether or not another major channel number is input (S110).

If another major channel number is not input until the preset time elapses after the major channel numbers have been completely input, it is determined whether or not any stored major channel number is present (S190). If present, a major channel corresponding to the stored major channel numbers is selected through the tuner demodulator 10 (S200).

In the process as described above, if any one of the major channel numbers is not consistently input for the first preset time, it is determined whether or not another major channel number is input until a preset time elapses after the major channel numbers have been completely input. If the other major channel number is input, this major channel number is stored (S120), and it is determined whether or not the other major channel number is consistently input for the first preset time (S130).

Specifically, in the process of sequentially inputting major channel numbers, it is determined whether or not each of the major channel numbers is consistently input for the first preset time in each input of the major channel numbers. If any one of the major channel numbers is not consistently input for the first preset time, it is determined whether or not another major channel number is input until the preset time elapses after a prior major channel number has been completely input.

In this case, if the other major channel number is not input until the preset time elapses, a major channel corresponding to the currently stored major channel numbers is selected through the tuner demodulator 10. Conversely, if the other major channel number is input before an elapse of the preset time, the above-mentioned process is repeated.

If any one of the major channel numbers is consistently input, the major channel numbers inputted sequentially in the above process and a delimiter to divide the major channel numbers from a minor channel number are displayed (S150).

If the major channel number is consistently input for the first preset time, it is determined whether or not a second preset time elapses (S160), and determined whether or not a minor channel number is input before the elapse of the second preset time (S170).

In this case, if the minor channel number is not input before the elapse of the second preset time, a major channel corresponding to the currently stored major channel numbers is selected by the tuner demodulator 10 (S200).

Conversely, if the minor channel number is input before the elapse of the second preset time, a minor channel corresponding to this minor channel number is selected (S180).

For example, in the case where a major channel number is No. 12, when numeral key ‘1’ is input, ‘1’ is stored, and, it is determined whether or not the numeral key ‘1’ is consistently input for a first preset time.

When ‘1’ is not consistently input for the first preset time and numeral key ‘2’ is input, ‘2’ is stored, and, it is determined whether or not the numeral key ‘2’ is consistently input for the first preset time.

If the numeral key ‘2’ is consistently input for the first preset time, a two-digit major channel number ‘12’ and a delimiter ‘-’ are displayed.

In this manner, if a minor channel number is input before an elapse of a second preset time after displaying the two-digit major channel number and the delimiter, a minor channel corresponding to the minor channel number is selected.

Similarly, a three-digit major channel number can be selected by the process as described above.

That is, the minor channel selection method for the digital television according to this embodiment of the present invention enables selection of the minor channel only with the numeral keys in such a fashion of consistently inputting the major channel number for the first preset time and then inputting the minor channel number, thereby making it unnecessary to input a separate delimiter to divide the major channel number from the minor channel number.

As apparent from the above description, with the method according to the present invention, it is possible to conveniently select a minor channel since no delimiter is needed to be inputted between major and minor channel numbers to divide them from each other.

Furthermore, according to the present invention, a key input unit such as a remote controller does not require a separate key to input the delimiter, reducing manufacture costs.

Although the present invention has been described with reference to the embodiments, it is not limited to the embodiments described herein. It should be understood that various modifications and changes can be made by those skilled in the art without departing from the spirit and scope of the present invention defined by the accompanying claims.

What is claimed is:

1. A minor channel selection method for a digital television, comprising:
storing a major channel number in response to an input of the major channel number, followed by determining whether or not the major channel number is consistently input for a first preset time;
determining whether or not a minor channel number is input before an elapse of a second preset time after a complete input of the major channel number, if the major channel number is consistently input for the first preset time; and
selecting a minor channel corresponding to the minor channel number, if the minor channel number is input before the elapse of the second preset time.

2. The method according to claim 1, wherein if the minor channel number is not input before the elapse of the second preset time, a major channel corresponding to the stored major channel number is selected.

3. The method according to claim 1, further comprising:
displaying a delimiter to divide the major channel number from the minor channel number, and the major channel number, if the major channel number is consistently input for the first preset time.

4. A minor channel selection method for a digital television, comprising:
storing major channel numbers in response to each input of the major channel numbers, followed by determining whether or not a last major channel number of the major channel numbers is consistently input for a first preset time;
determining whether or not a minor channel number is input before an elapse of a second preset time after a complete input of the last major channel number, if the last major channel number is consistently input for the first preset time; and
selecting a minor channel corresponding to the minor channel number, if the minor channel number is input before the elapse of the second preset time.

5. The method according to claim 4, wherein if the minor channel number is not input before the elapse of the second preset time, a major channel corresponding to the stored major channel numbers is selected.

6. The method according to claim 4, further comprising:
displaying a delimiter to divide the major channel numbers from the minor channel number, and the major channel numbers, if the last major channel number is consistently input for the first preset time.
